(19) United States
(12) Patent Application Publication
(10) Pub. No.: US 2004/0239101 A1
(43) Pub. Date: Dec. 2, 2004

(54) Self-adhesive management tag with opening mark indicating function and mehod of using the same

(76) Inventors: Masafumi Mitsuhashi, Kanagawa (JP); Yukako Natsume, Tokyo (JP)

Correspondence Address: SUGHRUE MION, PLLC, 2100 PENNSYLVANIA AVENUE, N.W., SUITE 800, WASHINGTON, DC, 20037, US

(21) Appl. No.: 10/478,806

(22) PCT Filed: Jun. 2, 2003
(86) PCT No.: PCT/JP03/06953

(51) Int. Cl. B42D 15/00

(52) U.S. Cl. 283/81; 428/343

(57) ABSTRACT

The present invention provides a management tag which comprises a base material having an unsealed mark display function and an adhesive layer formed on a part or all of a surface of backside of the base material, wherein the adhesive layer comprises at least one adhesive selected from the group consisting of polyurethane adhesives and polyester adhesives, and has a ball tack value of not more than 3, an adhesive strength value to stainless steel board according to JIS Z0237 of not more than 2 N/cm and adhesive strength value between adhesive layers at 24 hours in leaving without pressure after adhesion by pressure of adhesive layer sides together of 2 to 50 N/cm.

The management tag of the present invention can be fitted an article by winding around the article and then adhering the adhesive layer sides together. If the management tag of the present invention is tried to exchange for adhering to other article after the management tag was fitted to the article, the unsealed facts of the management tag can be recognized and further the transferring of adhesive to the surface of the article can be prevented.

### BACKGROUND OF THE INVENTION

1. Field of the Invention

The present invention relates to a self-adhesive management tag which can fit by winding around a commercial article such as spectacle frames and precious metal goods like rings, display information such as a price on the commercial article, and recognize unsealed facts of the management tag if the management tag is peeled after the fitting and then is fitted by adhesion again, and further can prevent transferring of adhesive to the surface of the article, and a method of use thereof.

2. Description of the Prior Art

As price tags for commercial articles such as spectacle frames and precious metal goods like rings, models of price tag having a strong bond which can be joined to the article with the strong bond, and models of label having an pressure-sensitive adhesive applied on the surface of backside of a price tag which can be fitted by winding around the article with the pressure-sensitive adhesive layer, have been employed conventionally and generally.

However, if the models of price tag having a strong bond, which can be joined to the article with the strong bond, are needed to remove from the article after fitting to the article, there are a problem that it needs an extra operation for using a strong cutter when removing the price tag and therefore it is not possible to remove the price tag quickly and a problem that the commercial articles may be injured by the cutter. There is also a problem that the management tag lacks the preventing ability of tamper, because the price tag removed from the commercial article can be fitted to another commercial article though it takes the extra operation.

With respect to the models of label having the pressure-sensitive adhesive applied on the surface of backside of the price tag which can be fitted by winding around the article with the pressure-sensitive adhesive layer, there are problems that the pressure-sensitive adhesive is transferred to the commercial article and therefore stains and modifies the commercial article and that the pressure-sensitive adhesive transfers to the hand at the fitting of the price tag and stains the hand.

Further, labels having the unsealed mark display function for preventing ability of tamper has been known in recent years. The labels have a strong tackiness pressure-sensitive adhesive layer formed on the surface of backside of the base material having the unsealed mark display function.

However, if the labels are fitted to the commercial article and then peeled from the commercial article, the tamper is confirmed by transfer of the pressure-sensitive adhesive layer to the commercial article. Therefore, there is a problem that the labels stain the commercial article.

Also, there is a problem that it is not possible to use the labels, because the unsealed mark display function may develop by peeling of the base material if the pressure-sensitive adhesive layer of the label adheres to the hand and the like at fitting to the commercial article and then the label is peeled from the hand and the like.

For solving the problems described above, it is considered that a covering film having non-pressure-sensitive adhesiveness is formed on the surface of the pressure-sensitive adhesive layer, which contacts to the commercial article. But, there are problems that it needs a process for forming the covering film having non-pressure-sensitive adhesiveness, it complicates the process for preparing the label and the cost for preparation of the label becomes higher.

### BRIEF SUMMARY OF THE INVENTION

Object of the Invention

The present invention is achieved in view of the situation of the conventional technology described above. The invention is to provide a management tag which is difficult to exchange for fitting from the article fitted with the tag to the other articles and can prevent transferring of adhesive to the surface of an article, when the management tag is fitted by winding around the article such as commercial articles and adhering one side of the adhesive layer of the management tag with the other side of the adhesive layer of the management tag, and further which can develop the unsealed mark display function of the base material by peeling the tag at the interface between the adhesive layer and the base material having the unsealed mark display function without peeling of the tag at the interface between the adhesive layers or by peeling the tag at the surface of backside of the base material having the unsealed mark display function together with peeling of the tag at the interface between the adhesive layers, if the tag is tried to peel at the interface between the adhesive layers.

Summary of the Invention

As a result of efforts by the present inventors to solve the above-described problems, it was found that the object of the present invention is achieved by forming an adhesive layer comprising at least one adhesive selected from the group consisting of polyurethane adhesives and polyester adhesives, and having a ball tack value of not more than 3, adhesive strength value to a stainless steel board according to JIS Z0237 of not more than 2 N/cm, and adhesive strength value between adhesive layers at 24 hours in leaving without pressure after adhesion by pressing adhesive layer sides together of 2 to 50 N/cm, on the surface of backside of base material having unsealed mark display function. And thus the present invention is completed.

That is to say, the present invention provides a management tag which comprises a base material having an unsealed mark display function and an adhesive layer formed on a part or all of a surface of backside of the base material, wherein the adhesive layer comprises at least one adhesive selected from the group consisting of polyurethane adhesives and polyester adhesives, and has a ball tack value of not more than 3, an adhesive strength value to stainless steel board according to JIS Z0237 of not more than 2 N/cm and adhesive strength value between adhesive layers at 24 hours in leaving without pressure after adhesion by pressure of adhesive layer sides together of 2 to 50 N/cm.

The present invention also provides the management tag as described above, wherein the adhesive layer has type A durometer hardness according to JIS K6253 of not less than 20.

The present invention also provides the management tag as described above, wherein the base material having the unsealed mark display function is a base material in which a release layer is partially formed on a surface of backside of the base material.

The present invention further provides the management tag as described above, wherein the base material having the unsealed mark display function is a base material in which a release layer is partially formed on a surface of backside of the base material and an easy breakable thin film layer is covered on the release layer and the surface of backside of the base material in which the release layer is not formed, wherein an adhesive strength between the easy breakable thin film layer and the surface of backside of the base material is larger than an adhesive strength between the easy breakable thin film layer and the adhesive layer.

The present invention furthermore provides a method of use of the management tag, which comprises displaying management information to the management tag as described above, winding the management tag around an article, fitting the management tag by adhering the adhesive layer sides together, and managing the article.

The present invention will be explained in detail as follows.

### BRIEF DESCRIPTION OF THE DRAWINGS

FIG. 1 shows a cross-section of a management tag of one embodiment of the invention;

FIG. 2 shows a cross-section of a state that a management tag of one embodiment of the invention is peeled after the management tag is adhered with the adhesive layer sides together;

FIG. 3 shows a cross-section of a management tag of other one embodiment of the invention;

FIG. 4 shows a cross-section of a state that a management tag of other one embodiment of the invention is peeled after the management tag is adhered with the adhesive layer sides together;

FIG. 5 shows a perspective diagram showing a state that a management tag of one embodiment of the invention is fitted by winding around a spectacle frame;

In drawings, 1 means a base material, 2 means a release layer, 3 means an easy breakable thin film layer, 4 means an adhesive layer, 5 means a release liner, 6 means a spectacle frames and a management tag.

### DETAILED DESCRIPTION OF THE PREFERRED EMBODIMENTS

In the present invention, the base material is preferably a sheet or film composed of a thermoplastic resin.

As the sheet or film composed of the thermoplastic resin, for example, the sheets or films composed of one or more of various synthetic resins, such as polyolefins like polyethylene resins of high density polyethylene, middle density polyethylene, low density polyethylene and the like, polypropylene resins of polypropylene and the like, polymethyl-1-pentene/ethylene/cyclic olefin copolymer, and ethylene-vinyl acetate copolymer; polyester resins like polyethylene terephthalate, polyethylene naphthalate, polybutylene terephthalate: polyvinyl chloride resins; polyvinylalcohol resins; polycarbonate resins; polyamide resins; polyimide resins; fluororesins; copolymers containing two or more polymerization units thereof; polymer blends containing two or more resins thereof, polymer alloys containing one or more resins thereof can be used. In particularly, the sheets or films composed of polyester resins are preferably used. The base material may be oriented uniaxially or biaxially. The base material may be composed of single layer or two or more layers of different layers or same layers.

Thickness of the base material does not have any limitation. However, the thickness is generally in the range of 10 to 300 μm and preferably in the range of 20 to 200 μm.

The shape of the base material does not have any limitation and includes polygons such as quadrangle like square and rectangle, and the like. Each side of the shape of the base material can have roundness and each corner of the shape of the base material can have roundness.

The size of the base material does not have any limitation, if it is a functionable size as the management tag. The width of the base material is generally in the range of 0.5 to 20 cm. The length of the base material is generally in the range of 3 to 50 cm.

The base material may be colored or colorless and transparent, and is preferably transparent or translucent. Moreover, general printing, character printing or the like may be given on the surface of the base material or the surface of backside of the base material for displaying needed information. For this purpose, a thermal recording layer, a print receiving layer allowing thermal transfer, ink jet, laser printing, gravure printing, flexo printing, screen printing, or a printing performance-improved layer etc. may be formed on the base material.

The base material has the unsealed mark display function. The base material having the unsealed mark display function is explained in the following, based on drawings.

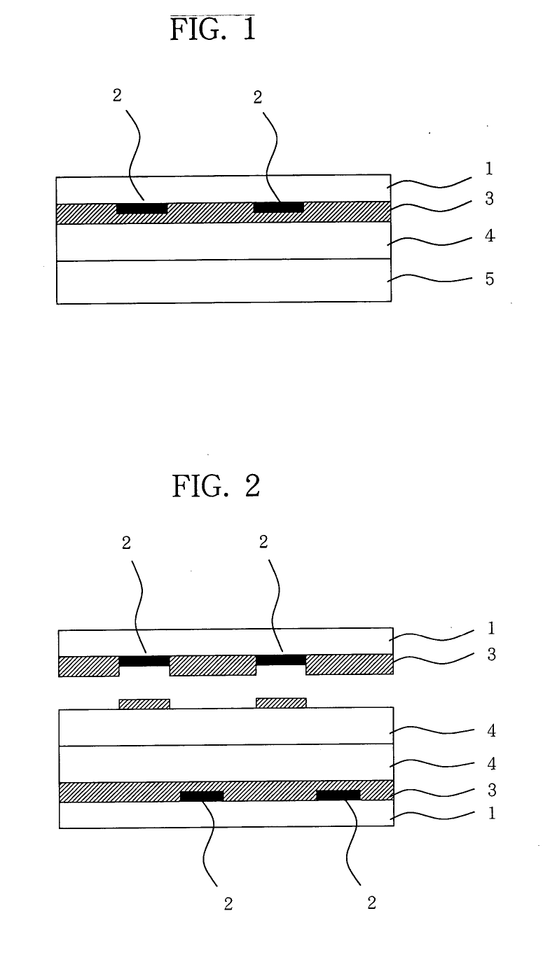

Examples of the base material having the unsealed mark display function are, for example, a base material in which a release layer 2 is partially formed on a surface of backside of the base material 1 and an easy breakable thin film layer 3 is covered on the release layer 2 and the surface of backside of the base material 1 in which the release layer 2 is not formed, as shown in FIG. 1. The adhesive strength between the easy breakable thin film layer 3 and the surface of backside of the base material 1 is needed to be larger than an adhesive strength between the easy breakable thin film layer 3 and the adhesive layer 4 in the base material. For increasing the adhesive strength between the release layer 2 and the surface of backside of the base material 1, and the adhesive strength between the easy breakable thin film layer 3 and the surface of backside of the base material 1, the surface of backside of the base material may be surface-treated or an adhesive layer may be formed in the interface between the surface of backside of the base material 1 and the release layer 2 or in the interface between the surface of backside of the base material 1 and the easy breakable thin film layer 3. Also, the release layer 2 can be peeled at the interface of the easy breakable thin film layer 3. The adhesive strength is preferably not more than 1.5 N/cm, more preferably not more than 1 N/cm, in general. When release liner 5 is formed on the surface of the adhesive layer 4 as described after, the adhesive strength between the release layer 2 and the easy breakable thin film layer 3 is preferably larger than the adhesive strength between the adhesive layer 4 and the release liner 5.

The release layer 2 is preferably composed of a thin film of resin or a thin film of release agent. The resin includes, for example, resins having releasability such as acrylic resins, polyester resins, fluororesins, melamine resins and polyurethane resins. As release agent, silicone resin release agents and non-silicone resin release agents such as polyvinyl carbamates resins, polyolefin resins, long-chain alkyl compounds and the like are illustrated. The release layer 2 may be transparent or translucent and be colored. When the base material 1 is transparent or translucent, the color of the release layer 2 is preferably the same color as the base material 1 or the easy breakable thin film layer 3 to be not able to recognize easily the release layer by observation from the surface side of the base material 1, more preferably transparent or translucent.

The release layer 2 can be formed by forming partially a thin film on the surface of backside of the base material by various means such as applying, spraying and printing of a resin or a release agent.

The thickness of the release layer 2 is not particularly limited, but in general is preferably in the range of 0.05 to 10 μm, more preferably in the range of 0.1 to 5 μm.

As the shape of the release layer 2, for example, letter, sign, figure, pattern and combinations of two or more members thereof are illustrated.

As the easy breakable thin film layer 3, metal thin films, resin thin films and the like are illustrated. The metal thin films include, for example, thin films composed of metal of aluminium, gold, silver, copper, copper alloy, iron, iron alloy, nickel or the like. The easy breakable thin film layer 3 can be formed by metal plating, vapor deposition, sputtering, CVD (chemical vapor deposition) or the like, preferably vapor deposition. The resin thin film include thin films composed of at least one member of resins such as acrylic resins, polyester resins and polycarbonate resins, and adhesives thereof. The resin film may be transparent or colored.

The thickness of the easy breakable thin layer 3 is not particularly limited, but is preferably in the range of 0.01 to 1 μm, more preferably in the range of 0.05 to 0.1 μm.

As shown in FIG. 2, for the constitution described above, if the management tag A of the present invention is peeled after adhesion by laminating and pressing the surfaces of the adhesive layer 4, the management tag A is not peeled at the interface between the surfaces of adhesive layer 4 because the adhesive strength between the surfaces of adhesive layer 4 is strong. In the surface of backside of the base material 1, in which the release layer 2 is not formed, the management tag A is peeled at the interface of the easy breakable thin layer 3 and the adhesive layer 4. Further, in the surface of backside of base material 1 having release layer 2, the management tag A is peeled at the interface between the release layer 2 and the easy breakable thin layer 3, and the easy breakable thin layer 3 formed on the surface of the release layer 2 and the adhesive layer 4 are peeled together as the lamination is. Accordingly, the easy breakable thin film layer 3 is broken around the release layer 2 and the easy breakable thin film layer 3 is peeled in shape of the release layer 2 from the release layer 2. As the result, the easy breakable thin film layer 3 lack from the surface of the release layer 2 and therefore the shape can be recognized and the peeled fact can be judged. Also, even if the peeled management tag A is tried to laminate again for returning into the original position, the peeled management tag A can be not adhered.

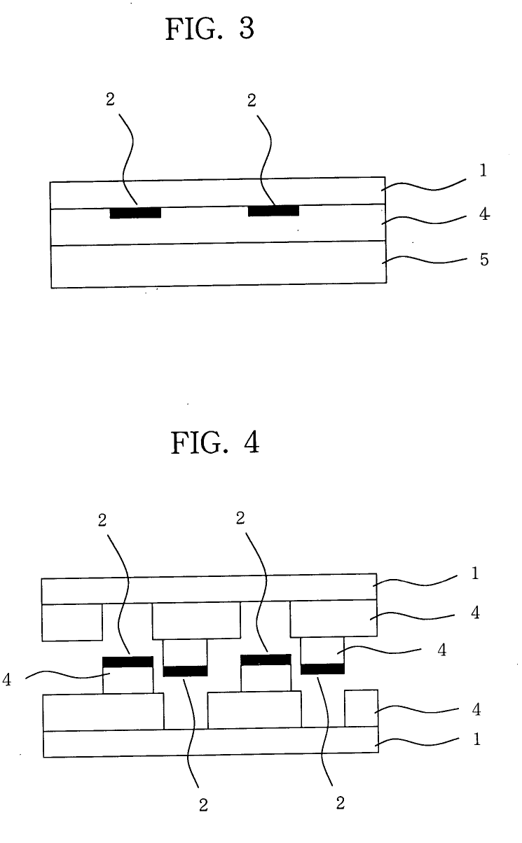

As other example of the base material having the unsealed mark display function, for example, a base material having transparent or translucent release layer 2 formed partially on the surface of backside of transparent or translucent base material 1 as shown in FIG. 3 is illustrated. In the base material, transparent or translucent base material 1 and transparent or translucent release layer 2 are the same as transparent or translucent base material 1 and transparent or translucent release layer 2 in the example of the base material having the unsealed mark display function described before. The adhesive strength between the surface of backside of base material 1 without release layer 2 and adhesive layer 4 is needed to be larger than an adhesive strength between two adhesive layers 4. For increasing the adhesive strength between the surface of backside of base material land adhesive layer 4, the surface of backside of base material 1 may be surface-treated, or another adhesive layer having large adhesive strength may be formed in the interface between the surface of backside of base material 1 and adhesive layer 4. The release layer 2 can peel from the surface of backside of base material 1. In general, the adhesive strength is preferably not more than 1.5 N/cm, more preferably not more than 1 N/cm. When release liner 5 is provided on the surface of adhesive layer 4 described after, the adhesive strength between release layer 2 and adhesive layer 4 is preferably larger than the adhesive strength between adhesive layer 4 and release liner 5.

As shown in FIG. 4, for the constitution described above, if the management tag A of the present invention is peeled after adhesion by laminating and pressing the surfaces of the adhesive layer 4 together, the management tag A is peeled at the interface between two adhesive layers 4 in the surface of backside of the base material 1, in which the release layer 2 is not formed. In the surface of backside of base material 1 having release layer 2, the management tag A is peeled at the interface of release layer 2 and base material 1. And release layer 2 is peeled together with the adhesive layer 4 as the lamination is. Accordingly, adhesive layer 4 is broken around the release layer 2 and release layer 2 is peeled from the surface of backside of base material 1. Therefore, a void is produced between release layer 2 and the surface of backside of base material 1. By the void, transmitted light is irregularly reflected, and therefore, the portion of release layer 2 becomes opaque. On the other hand, the management tag is not peeled at the interface between the surface of back side of base material 1 without release layer 2 and adhesive layer 4, and therefore, transparency is kept. Accordingly, the contrast of the opaque portion and the transparent portion is recognized by visual and the peeled fact can be recognized and judged. Also, even if the peeled management tag A is tried to laminate again for returning into the original position, the peeled management tag A can be not adhered.

In the present invention, an adhesive layer comprising at least one adhesive selected from the group consisting of polyurethane adhesives and polyester adhesives is formed on a part or whole of the surface of the base material.

The adhesive layer in the present invention has characteristic to have extremely low tackiness, and the ball tack value is not more than 3, and preferably not more than 2. If the ball tack value exceeds 3, adhesive may remains on the surface of articles fitted with the management tag.

Moreover, the adhesive layer has adhesive strength value to a stainless steel board according to JIS Z0237 of not more than 2 N/cm, and preferably not more than 1.5 N/cm.

In addition, the adhesive layer has adhesive strength value between adhesive layers at 24 hours in leaving without pressure after adhesion by pressure of adhesive layer sides together of 2 to 50 N/cm, preferably 3 to 50 N/cm.

A polyurethane adhesive layer has characteristic that the adhesive strength becomes strong immediately after adhering the adhesive layer sides together and the obtained adhesive strength maintains as it is. A polyester adhesive layer has characteristic that the adhesive layer is easily peeled off immediately after adhering the adhesive layer sides together and the adhesion strength increases gradually.

Furthermore, type A durometer hardness according to JIS K6253 of the adhesive layer is preferably not less than 20, more preferably in the range of 30 to 100, and most preferably in the range of 40 to 80. When type A durometer hardness is less than 20, there is the fear that the adhesive may remain on articles fitted with the management tag. On the other hand, sufficient adhesive strength may not be obtained when the hardness is more than 100.

The polyurethane adhesive employed in the above-described adhesive layer is composed of a soft segment mainly composed of long-chain polyol and a hard segment composed of diisocyanate and chain extender. As long-chain polyols, polyester polyol, polyether polyol are mainly employed, and as diisocyanates, tolylene diisocyanate, diphenylmethane diisocyanate, hexamethylene diisocyanate and the like are used. As chain extenders, low molecule polyalcohols and aromatic diamines, etc. are used.

The polyurethane adhesive is preferable that cured afterwards by adding a cross linking agent into polyurethane. Polyisocyanates are preferable as a cross linking agent, and aliphatic or cycloaliphatic polyisocyanates are especially preferable in view of weatherability. In addition, when the cross linking agent is used, it is preferable to add a cross linking accelerator in combination.

Polyisocyanate-based cross linking agents are polyisocyanate compounds having not less than 2 of isocyante groups in a molecule. Examples of this kind of cross linking agents are shown below; 1,4-tetramethylene diisocyanate, hexamethylene diisocyanate, 2,2,4-trimethylhexane-1,6-diisocyanate, lysinemethylester diisocyanate, p-phenylene diisocyanate, tolylene diisocyanate, biphenyl diisocyanate, 3,3′-dimethyl-4,4′-biphenylene diisocyanate, methylene bis(phenyl isocyanate), bis(isocyanate ethyl)fumarate, isophorone diisocyanate, methylcyclohexyl diisocyanate, 2-isocyanate ethyl-2,6-diisocyanatehexanoate. Moreover, modified isocyanates thereof, for example, multi-functional isocyanate compounds having not less than 3 functional groups such as isocyanurate type and urethane type may be used. The amount of the cross linking agent is preferably in the range of 1 to 60 parts by weight based on the weight of 100 parts by weight of polyurethane, and more preferably in the range of 10 to 40 parts by weight.

Polyester adhesives employed in the above-described adhesive layer contain a polyester resin as a resin component.

The polyester resin in the polyester adhesive is obtained by polycondensation of an acid component and a diol component. As the acid component, for example, aliphatic dicarboxylic acid and aromatic dicarboxylic acid may be illustrated, but these two types of dicarboxylic acids may be used in combination. When an aliphatic dicarboxylic acid and an aromatic dicarboxylic acid are used in combination, a ratio by weight of the aliphatic dicarboxylic acid and the aromatic dicarboxylic acid is preferably in the range of 5:95 to 50:50. As aliphatic dicarboxylic acids, for example, adipic acid, sebacic acid, azelaic acid and decane-1,10-dicarboxylic acid may be illustrated. As aromatic dicarboxylic acids, for example, terephthalic acid, isophthalic acid, phthalic acid, naphthalene-1,4-dicarboxylic acid, naphthalene-2,5-dicarboxylic acid, diphenylether-4,4′-dicarboxylic acid and diphenyldicarboxylic acid may be illustrated. As the diol component, for example, aliphatic diols and aromatic diols may be illustrated, but aliphatic diols are preferable. One aliphatic diol may be used, but two or more members, particularly two to four members of aliphatic diols are preferably used in combination. As aliphatic diols, for example, ethylene glycol, propylene glycol, trimethylene glycol, tetramethylene glycol, diethylene glycol, polyethylene glycol, polypropylene glycol, polytetramethylene glycol, hexamethylene glycol, dodecamethylene glycol and neo-pentyl glycol may be illustrated.

A cross linking agent may be added to the polyester resin as the resin component in the polyester adhesive.

Polyisocyanate-based cross linking agent is preferable as the cross linking agent. As the polyisocyanate-based cross linking agents, it is possible to use the same as those described as the polyisocyanate-based cross linking agents used in polyurethanes. The amount of the cross linking agent is preferably in the range of 1 to 20 parts by weight based on the weight of 100 parts by weight of polyester resin, and more preferably in the range of 2 to 10 parts by weight.

After cross linking the polyester resin and the polyurethane resin used in the adhesive layer of the present invention, a glass transition temperature of the cross-linked polyester resin and the cross-linked polyurethane resin is preferably in the range of −20° C. to +60° C.

In the above-described adhesive layer, polyester adhesives and polyurethane adhesives may be used in mixture. A mixing ratio of polyester adhesives and polyurethane adhesives is preferably in the range of 5:95 to 95:5 by mass ratio. The management tag having desired adhesive strength can be obtained by using the two types of adhesives in mixture.

The adhesive layer of the present invention preferably does not contain substantially a tackifier, an oil and a plasticizer, unlike conventional adhesive layers. Because of this, the adhesive layer of the present invention has superior chemical stability, and the surface of articles fitted with the management tag can be prevented from staining.

In addition, the adhesive layer may contain at least one member of other additives. As additives, dyestuffs, pigments, fillers, antioxidants and ultra-violet absorbents are illustrated as examples. As fillers, zincoxide, titanium oxide, silica, calcium carbonate, and barium sulfate are illustrated as examples. As antioxidants, anilide-, phenol-, phosphite-, and thioester-based antioxidants are illustrated as examples. As ultra-violet absorbents, benzophenone- and bonzotriazole-based ultra-violet absorbents are illustrated as examples.

Thickness of the adhesive layer does not have limitation particularly, but it is usually in the range of 5 to 40 μm, and preferably in the range of 10 to 25 μm.

The area that the adhesive layer is particularly not limited so long as the management tag of the present invention can be tightly fitted to the articles by adhering through pressing adhesive layer sides together of the management tag.

In addition, since the adhesive layer of the present invention has printability of pictures and characters, it is possible to put printed pictures or characters on a part of the surface of the adhesive layer.

Also, the surface of the adhesive layer may be covered with a release liner.

The release liner is composed of a support base material having a releasing property at least on one side of support base material. The surface of the side with releasing property of the support base material may be coated with a release agent or may not be coated with the release agent.

As support base materials of the release liner, for example, paper, synthetic paper and plastic film are illustrated. For example, as paper, a glassine paper and polyethylene laminate paper are illustrated, and as plastic films, films of polyolef in resins such as polyethylene resin and polypropylene resin, and of polyester resins such as polybutylene terephthalate resin and polyethylene terephthalate resin, and of acetate resins, of polystyrene resins and of polyvinylchloride resins are illustrated. In addition, as a suitable operative example of the release liner in which a release agent is not coated, polyolef in films such as polypropylene film, polyethylene film and papers and other films laminated with these polyolef in films are illustrated.

As a release agent used for a release liner, silicone resins, alkyd resins, fluorocarbon resins, and resins containing long-chain alkyl groups are illustrated.

Thickness of the release liner is not particularly limited and may be chosen appropriately.

The methods of forming the adhesive layer to the easy breakable thin film layer or the surface of backside of base material include a method of applying the adhesive to the easy breakable thin film layer or the surface of backside of base material and drying, a method of preparing a release liner with an adhesive layer by applying the adhesive to the surface of the release liner and drying, and then laminating the adhesive layer of the release liner with an adhesive layer on the easy breakable thin film layer or the surface of backside of the base material. The later is particularly preferable among them. Further, it is possible to control the viscosity of the adhesive used for application by adding a diluent, according to needs.

The management tag of the present invention can have a form of a plane sheet or a rolled shape.

The management tag of the present invention can be used for managing the article by fitting the article through displaying management information to the management tag and winding the management tag around the article and adhering adhesive layer sides together. The management information includes one or more information needed for managing the article, such as price of article, manufacturing serial number, manufacturing date, arrival date, material and method of treatment. The term “management” means to specify the article based on the management information and treat under the control of the manager.

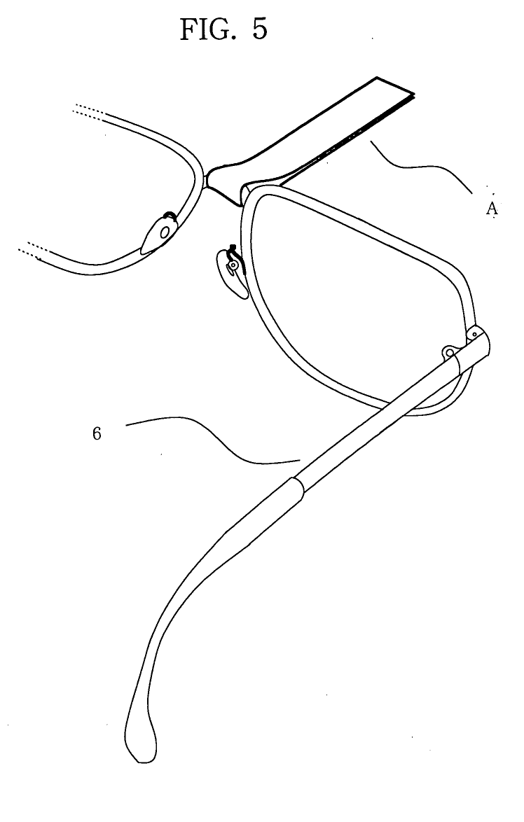

For fitting the management tag of the present invention to the article, for example, as shown in FIG. 5, it is preferable to wind around the article by placing the surface of the adhesive layer of management tag on the side of the article such as spectacle frames and to adhere by pressing adhesive layer sides of both ends of management tag A.

The management tag of the present invention can be fitted to articles such as spectacle frames and precious metal goods like rings.

### EXAMPLES

The present invention will be explained by an example more concretely in the next paragraph. In addition, the present invention was not restricted at all by these examples.

Adhesive strength measurement test, measurement test of adhesive strength between adhesive layers at 24 hours in leaving without pressure after pressing adhesive layer sides together, ball tack measurement test and measurement test of type A durometer hardness in examples were performed according to the methods as follows. The tests (1) to (4) were performed under room temperature.

(1) Adhesive strength measurement test:

Adhesive strength of an adhesive layer of a management tag was measured according to JIS Z 0237.8.3.1. Here stainless steel plate was used as testing board. Also, adhesive strength of the adhesive layer to the surface of base material was measured in the same method.

(2) measurement test of adhesive strength between adhesive layers at 24 hours in leaving without pressure after adhesion by pressing adhesive layer sides together:

Two adhesive layer sides of a management tag were located facing together and pressed, and left without pressure for 24 hours after adhesion by pressing, and then the adhered adhesive layer side was peeled off (in T type peeling) at peeling rate of 300 mm/min. The load of peeling was measured.

(3) Ball tack measurement test:

The ball tack of an adhesive layer of a management tag was measured according to JIS Z0237.12. Measurement was performed under the condition of inclination angle of board of 30°, and of unit of 1/32 inch.

(4) Measurement test of type A durometer hardness:

The type A durometer hardness of the adhesive layer was measured according to JIS K6253.5.4.

### Example 1

A release layer (thickness of 1 μm) was formed by printing a release agent (production of IPPO OIL AND FAT Co., Ltd., trade name “PEELOIL 1010”) in the letter shape of “VOID” which means to be already unsealed, on the surface of backside of polyethylene terephthalate film (thickness of 50 μm) as the base material and drying. And then, the aluminium vapor deposition thin film layer (thickness of 0.05 μm) was formed by vapor-depositing aluminium on the release layer and the residual portion of the surface of backside of base material in which a release layer was not formed. Thus, the polyethylene terephthalate film having unsealed mark display function was prepared.

A polyurethane adhesive solutionwas prepared by mixing 100 parts by weight of polyurethane resin (Dainichiseika Colour & Chemicals Mfg. Co., Ltd. REZAMINE UD8300LP, 50 weight % of non-volatile matter), 30 parts by weight of a cross linking agent of polyisocyanates compound (Dainichiseika Colour & Chemicals Mfg. Co., Ltd. REZAMINE NE, 75 weight % of non-volatile matter), and 0.5 parts by weight of amine/tin cross linking accelerator (Dainichiseika Colour & Chemicals Mfg. Co.,Ltd. REZAMINE HI215 ACCELERATOR, 5 weight % of non-volatile matter).

The polyurethane adhesive solution was applied on one side of the polypropylene film (Oji Seishi Co., Ltd., ALPHANE PP40 PU002, thickness 40 μm) as a release liner to obtain thickness of the adhesive layer after drying of 12 μm, the layer was dried. In the next step, the surface of the adhesive layer of the release liner having the adhesive layer was laminated with the surface of backside of the obtained polyethylene terephthalate film having the unsealed mark display function described above to form an adhesive sheet having the release liner. Management information such as a price of a commercial article was flexo-printed on the surface of base material in the adhesive sheet having the release liner. And, a management tag was made by die cutting the adhesive sheet having the release liner in the shape of rectangular (size: width of 1 cm and length of 5 cm) until the die cutting reached the release liner from the base material side.

The adhesive strength value of the polyurethane adhesive layer to a stainless steel plate measured according to JIS Z0237.8.3.1 was 0 N/cm. In addition, the adhesive strength value at 24 hours in leaving without pressure after adhesion by pressing the adhesive layer sides together was 8.2 N/cm. Further, the ball tack value of the adhesive layer was 2. Furthermore, the type A durometer hardness of the adhesive layer was 78.

The management tag was fitted to a spectacle frame by peeling the management tag from the release liner, winding the management tag around the spectacle frame, and adhering the adhesive layer sides together. The management tag was allowed to stand for one month after fitting to the spectacle frame and then was tried to remove from the spectacle frame. The management tag was not peeled at the adhesion interface between adhesive layers, but was peeled at the interface between the release layer and the aluminium vapor deposition thin film layer within the release layer having the letter shape of “VOID” (already unsealed), and at the interface between the aluminium vapor deposition thin film layer and the adhesive layer within the other portion. At the result, the display of “VOID” was developed. And then, the adhering of the management tag was tried, but it was impossible to adhere the management tag again. Also, adhesive residue, discoloration and stain to the spectacle frame were not observed.

### Example 2

A release layer (thickness of 1 μm) was formed by printing a release agent (production of IPPO OIL AND FAT Co., Ltd., trade name “PEELOIL 1010”) in the letter shape of “VOID” which means to be already unsealed, on the surface of backside of polyethylene terephthalate film (thickness of 50 μm) as the base material and drying. And then, the aluminium vapor deposition thin film layer (thickness of 0.05 μm) was formed by vapor-depositing aluminium on the release layer and the residual portion of the surface of backside of base material in which a release layer was not formed. Thus, the polyethylene terephthalate film having unsealed mark display function was prepared.

A polyester adhesive solution was prepared by mixing 100 parts by weight of phthalic acid-based polyester resin (Dainichiseika Colour & Chemicals Mfg. Co., Ltd. SEIKABOND E-295, 60 weight % of non-volatile matter) and 5 parts by weight of a cross linking agent of polyisocyanates compound (Dainichiseika Colour & Chemicals Mfg. Co., Ltd. SEIKABOND C-75N, 75 weight % of non-volatile matter).

The polyester adhesive solution was applied on one side of the polypropylene film (Oji Seishi Co., Ltd., ALPHANE PP40 PU002, thickness 40 μm) as a release liner to obtain thickness of the adhesive layer after drying of 20 μm, the layer was dried. In the next step, the surface of the adhesive layer of the release liner having the adhesive layer was laminated with the surface of backside of the obtained polyethylene terephthalate film having the unsealed mark display function described above to form an adhesive sheet having the release liner. Management information such as a price of commercial article was flexo-printed on the surface of base material in the adhesive sheet having the release liner. And, a management tag was made by die cutting the adhesive sheet having the release liner in the shape of rectangular (size: width of 1 cm and length of 5 cm) until the die cutting reached the release liner from the base material.

The adhesive strength value of the polyester adhesive layer to a stainless steel plate measured according to JIS Z0237.8.3.1 was 0.2 N/cm. In addition, and the adhesive strength value at 24 hours in leaving without pressure after adhesion by pressing was 6.7 N/cm. Further, the ball tack value of the adhesive layer was 2. Furthermore, the type A durometer hardness of the adhesive layer was 40.

The management tag was fitted to a spectacle frame by peeling the management tag from the release liner, winding the management tag around the spectacle frame, and adhering the adhesive layer sides together. The management tag was allowed to stand for one month after fitting to the spectacle frame and then was tried to remove from the spectacle frame. The management tag was not peeled at the adhesion interface between adhesive layers, but was peeled at the interface between the release layer and the aluminium vapor deposition thin film layer within the release layer having letter shape of “VOID”, and at the interface between the aluminium vapor deposition thin film layer and the adhesive layer within the other portion. At the result, the display of “VOID” was developed. And then, the adhering of the management tag was tried, but it was impossible to adhere the management tag again. Also, adhesive residue, discoloration and stain to the spectacle frame were not observed.

### Example 3

A release layer (thickness of 1 μm) was formed by printing a release agent (production of IPPO OIL AND FAT Co., Ltd., trade name “PEELOIL 1010”) in the letter shape of “VOID” which means to be already unsealed, on the surface of backside of polyethylene terephthalate film (thickness of 50 μm) as the base material and drying. Thus, the polyethylene terephthalate film having unsealed mark display function was prepared.

A polyester adhesive solution was prepared by mixing 100 parts by weight of phthalic acid-based polyester resin (Dainichiseika Colour & Chemicals Mfg. Co., Ltd. SEIKABOND E-295, 60 weight % of non-volatile matter) and 5 parts by weight of a cross linking agent of polyisocyanates compound (Dainichiseika Colour & Chemicals Mfg. Co., Ltd. SEIKABOND C-75N, 75 weight % of non-volatile matter).

The polyester adhesive solution was applied on one side of the polypropylene film (Oji Seishi Co., Ltd., ALPHANE PP40 PU002, thickness 40 μm) as a release liner to obtain thickness of the adhesive layer after drying of 20 μm, the layer was dried. In the next step, the surface of the adhesive layer of the release liner having the adhesive layer was laminated with the surface of backside of the obtained polyethylene terephthalate film having the unsealed mark display function described above to form an adhesive sheet having the release liner. Management information such as a price of commercial article was flexo-printed on the surface of base material in the adhesive sheet having the release liner. And, a management tag was made by die cutting the adhesive sheet having the release liner in the shape of rectangular (size: width of 1 cm and length of 5 cm) until the die cutting reached the release liner from the base material.

The adhesive strength value of the polyester adhesive layer to a stainless steel plate measured according to JIS Z0237.8.3.1 was 0.2 N/cm. In addition, and the adhesive strength value at 24 hours in leaving without pressure after adhesion by pressing was 6.7 N/cm. Further, the ball tack value of the adhesive layer was 2. Furthermore, the type A durometer hardness of the adhesive layer was 40.

The management tag was fitted to a spectacle frame by peeling the management tag from the release liner, winding the management tag around the spectacle frame, and adhering the adhesive layer sides together. The management tag was allowed to stand for one month after fitting to the spectacle frame and then was tried to remove from the spectacle frame. The management tag was difficult to be peeled at the adhesion interface between adhesive layers, but further was tried to peel forcibly. The management tag was peeled at the interface between the adhesive layers without the release layer and at the interface between the base material and the release layer within the release layer having letter shape of “VOID”, At the result, the display of “VOID” was developed. And then, the adhering of the management tag was tried, but it was impossible to adhere the management tag again. Also, adhesive residue, discoloration and stain to the spectacle frame were not observed.

The management tag of the present invention can be fitted an article by winding around the article and adhering the adhesive layer sides together. If the remove of the management tag of the present invention is tried from the article after the management tag was fitted to the article, the management tag is peeled at the interface between the adhesive layer and the base material having the unsealed mark display function without peeling of the tag at the interface between the adhesive layers or at the surface of backside of the base material having the unsealed mark display function together with peeling of the tag at the interface between the adhesive layers. At the result, the unsealed mark display function can be developed. Therefore, it is difficult to transfer the management tag from the article fitted with the management to the other article. The management tag can prevent adhesive residue, discoloration and stain to the article fitted with the management.

1. A management tag which comprises a base material having an unsealed mark display function and an adhesive layer formed on a part or all of a surface of backside of the base material, wherein the adhesive layer comprises at least one adhesive selected from the group consisting of polyurethane adhesives and polyester adhesives, and has a ball tack value of not more than 3, an adhesive strength value to stainless steel board according to JIS Z0237 of not more than 2 N/cm and adhesive strength value between adhesive layers at 24 hours in leaving without pressure after adhesion by pressure of adhesive layer sides together of 2 to 50 N/cm.

2. The management tag as claimed in claim 1, wherein the adhesive layer has type A durometer hardness according to JIS K6253 of not less than 20.

3. The management tag as claimed in claim 1, wherein the base material having the unsealed mark display function is a base material in which a release layer is partially formed on a surface of backside of the base material.

4. The management tag as claimed in claim 1, wherein the base material having the unsealed mark display function is a base material in which a release layer is partially formed on a surface of backside of the base material and an easy breakable thin film layer is covered on the release layer and the surface of backside of the base material in which the release layer is not formed, wherein an adhesive strength between the easy breakable thin film layer and the surface of backside of the base material is larger than an adhesive strength between the easy breakable thin film layer and the adhesive layer.

5. A method of use of the management tag, which comprises displaying management information to the management tag as claimed in claim 1, winding the management tag around an article, fitting the management tag by adhering the adhesive layer sides together, and managing the article.

6. The management tag as claimed in claim 2, wherein the base material having the unsealed mark display function is a base material in which a release layer is partially formed on a surface of backside of the base material.

7. The management tag as claimed in claim 2, wherein the base material having the unsealed mark display function is a base material in which a release layer is partially formed on a surface of backside of the base material and an easy breakable thin film layer is covered on the release layer and the surface of backside of the base material in which the release layer is not formed, wherein an adhesive strength between the easy breakable thin film layer and the surface of backside of the base material is larger than an adhesive strength between the easy breakable thin film layer and the adhesive layer.

8. A method of use of the management tag, which comprises displaying management information to the management tag as claimed in claim 2, winding the management tag around an article, fitting the management tag by adhering the adhesive layer sides together, and managing the article.

9. A method of use of the management tag, which comprises displaying management information to the management tag as claimed in claim 3, winding the management tag around an article, fitting the management tag by adhering the adhesive layer sides together, and managing the article.

10. A method of use of the management tag, which comprises displaying management information to the management tag as claimed in claim 4, winding the management tag around an article, fitting the management tag by adhering the adhesive layer sides together, and managing the article.
